(19) United States
(12) Patent Application Publication
(10) Pub. No.: US 2022/0300701 A1
(43) Pub. Date: Sep. 22, 2022

(54) SYSTEM AND USER INTERFACE FOR PEER REVIEW OF DOCUMENTS

(71) Applicant: Anthony Nicholas KALLOO, Baltimore, MD (US)

(72) Inventor: Anthony Nicholas KALLOO, Baltimore, MD (US)

(21) Appl. No.: 17/697,805

(22) Filed: Mar. 17, 2022

Related U.S. Application Data
(60) Provisional application No. 63/163,633, filed on Mar. 19, 2021.

(51) Int. Cl. G06F 40/169; G06F 40/197; G06F 16/34; G06F 3/0482

(52) U.S. Cl. CPC G06F 40/169; G06F 40/197; G06F 16/345; G06F 3/0482; G06F 2203/04803

(57) ABSTRACT

A method, system, one or more apparatus, and a computer-readable medium are presented for document review. The system includes a memory; and at least one processor coupled to the memory and configured to receive a written document for review and process the written document for review at a user interface. The system is configured to display the written document at a first portion of the user interface and receive one or more comments about the written document at an entry component at a second portion of the user interface. The system may further generate a document summarizing the comments entered at the user interface and transmit the document to an editor or author.

### CROSS REFERENCE TO RELATED APPLICATION(S)

This application claims the benefit of and priority to U.S. Provisional Application Ser. No. 63/163,633, entitled “SYSTEM AND USER INTERFACE FOR PEER REVIEW OF DOCUMENTS” and filed on Mar. 19, 2021, which is expressly incorporated by reference herein in its entirety.

### BACKGROUND

### Technical Field

The present disclosure relates generally to a computer processing system, and more particularly, to a method and system for providing a user interface for peer review of written articles.

### INTRODUCTION

A peer review system exists in scholarly publishing to validate academic work and to help to improve the quality of published research. An author may submit a written article for publication to a journal, for example. The journal, or an editor, may make an initial determination about whether certain requirements are met and/or may perform an initial review of the written article. If the written article passes the initial review, the article may be sent to one or more people with experience in a technical field relating to the subject matter of the written article for peer review by one or more people with a similar competency as the author. For example, a peer reviewer may be an expert in the technical area corresponding to the subject matter of the article. The peer reviewer may review the written article and provide comments to the editor, such as a recommendation to accept or reject the written article. The expert may also provide notes and editing comments about the article. Based on the comments from the peer reviewer(s), the editor may determine whether to accept or reject the written article. Even if accepted, the author may revise the article, e.g., based on comments from the peer review and/or the editor. The revised written article may be returned to the experts for their additional review and recommendation. Multiple iterations of review and revision may occur before an article proceeds to publication. Peer review provides a form of quality control by qualified members of a profession within the relevant field. As an example, scholarly peer review may refer to the process of subjecting an author's work, research, or ideas to the scrutiny of others who are experts in the same field, before the author's writings are published, e.g., in a journal, conference proceeding, or book. The peer review may assist an editor, publisher, committee, etc. in deciding whether to accept, accept with revisions, or reject a written article. Peer review may be used to maintain quality standards, improve performance, and provide credibility. In academic journals, for example, scholarly peer review, may be used to determine whether an academic paper is suitable for publication.

Providing editing comments and peer review of a written article can be a time consuming task for an expert in the field. Aspects presented herein provide tools to enable more efficient and accurate peer review by such experts.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes memory and at least one processor coupled to the memory. The memory and at least one processor are configured to receive a written document for review and process the written document for review at a user interface. The memory and at least one processor are further configured to display the written document at a first portion of the user interface and receive one or more comments about the written document at an entry component at a second portion of the user interface. The memory and at least one processor may be further configured to generate a document summarizing the comments entered at the user interface and transmit the document to an editor or author.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of the exchange of information between components of an editorial management system in accordance with aspects presented herein.

FIGS. 2A and 2B illustrate example aspects of a user interface for peer review of documents including an entry component for receiving peer reviewer comments in accordance with aspects presented herein.

FIGS. 3A, 3B, and 3C illustrate example aspects of a user interface for peer review of documents including a window for displaying a copy of an associated reference in accordance with aspects presented herein.

FIGS. 4A, 4B, and 4C illustrate example aspects of a user interface for peer review of documents including a window for displaying a copy of an associated table/appendix in accordance with aspects presented herein.

FIG. 5 illustrates example aspects of a user interface for peer review of documents including a spell check/grammar check for a particular technical field in accordance with aspects presented herein.

FIGS. 6A, 6B, and 6C illustrate example aspects of a user interface for peer review of documents including display of a preview of comments to be sent to the editorial system in accordance with aspects presented herein.

FIG. 7 illustrates example aspects of a user interface for peer review of documents including an article navigation tool in accordance with aspects presented herein.

FIG. 8 is a block diagram of various example system components, in accordance with aspects presented herein.

FIG. 9 illustrates a block diagram of an example computer system on which the aspects of the disclosed systems and methods can be implemented.

FIG. 10 is a flowchart of a method of providing a user interface for a document review process in accordance with aspects presented herein.

FIG. 11 is a diagram illustrating an example of a hardware implementation for an example apparatus/system configured to provide a user interface for a document review process in accordance with aspects presented herein.

FIG. 12 is a flowchart of a method of providing a spelling/grammar check based on a particular technical area at a user interface for a document review process in accordance with aspects presented herein.

FIG. 13 is a diagram illustrating an example of the exchange of information between components of an editorial system in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of an editing system will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

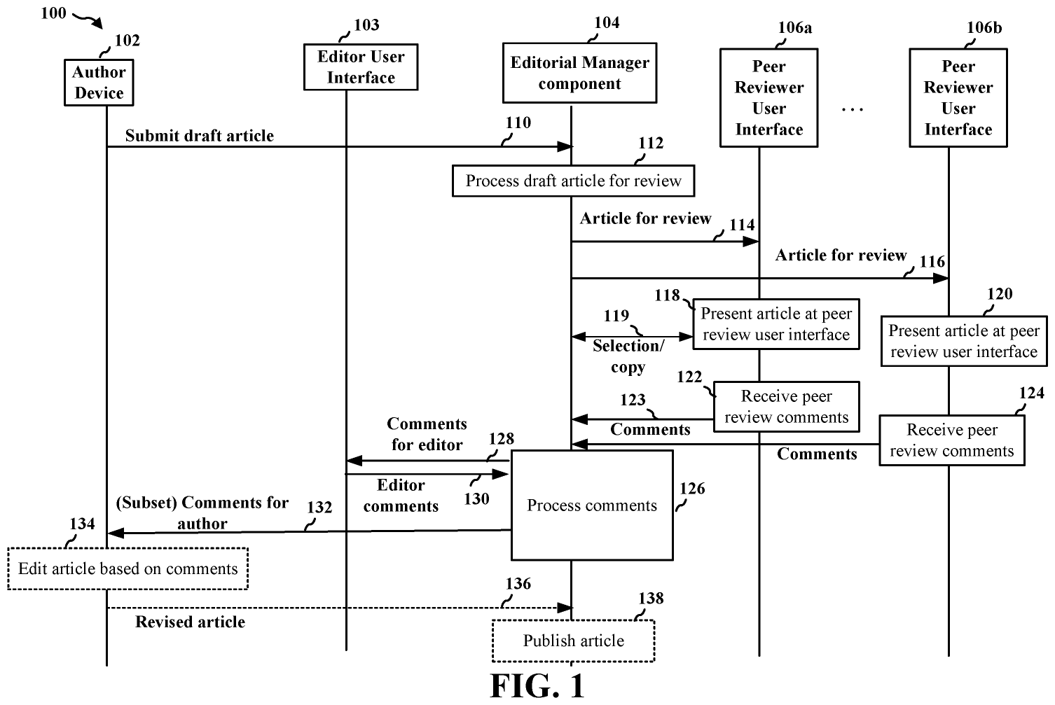

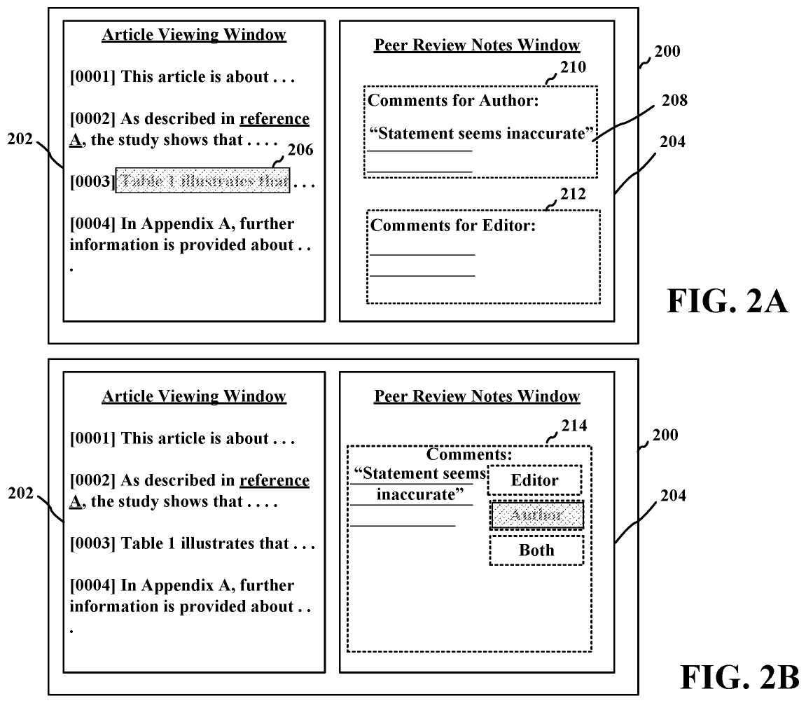

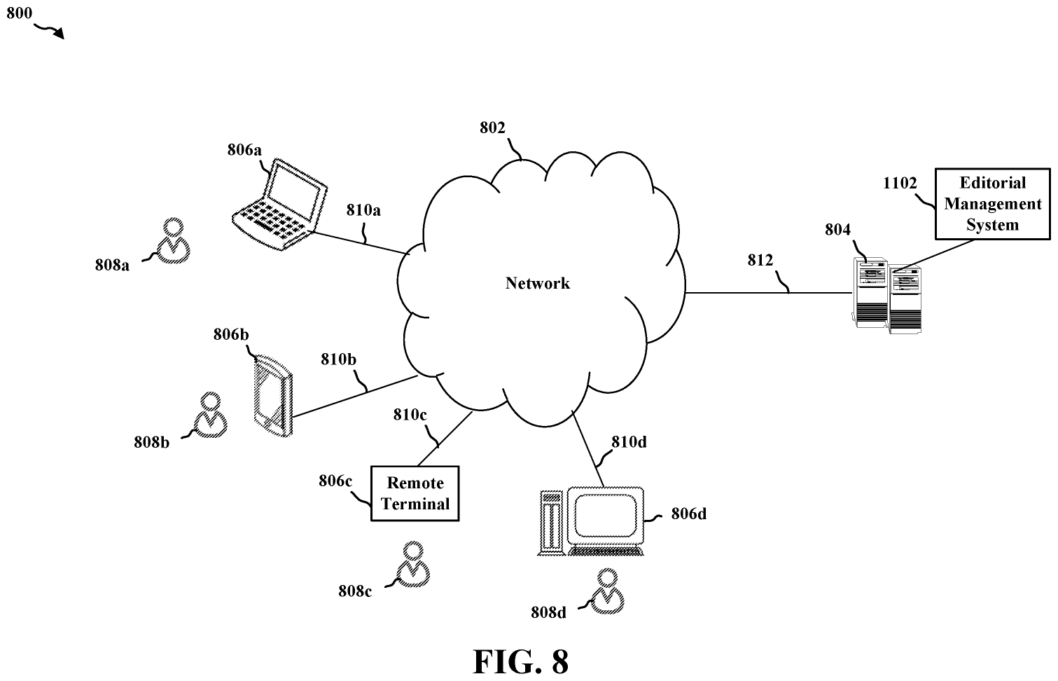

FIG. 1 is a diagram illustrating an example exchange of information 100 between components of an editorial management system. One or more of the aspects may be optional or may be applied in a different order than illustrated, in some aspects. A communication exchange may include any combination of the aspects illustrated and/or described in connection with FIG. 1, and may incorporate aspects described in connection with FIGS. 2A-13. As illustrated at 110, an author may submit a draft article for publication, e.g., in a journal, a conference proceeding, book, etc. For example, the author may submit the draft article 110 to the editorial manager component 104 via a device 102 or terminal, such as one of the terminals 806a-d described in connection with FIG. 8. In some aspects, the author may submit the draft article via an author user interface provided as part of an editorial management system. In other aspects, the author may submit the draft article via email or in some other manner, and the draft article may be input to the editorial management system after receipt from the author. As a part of determining whether to publish an article, and/or in preparation to publish an article, an editor may send the article for peer review by one or more experts in the technical field.

Peer review provides a form of quality control by qualified members of a profession within the relevant field. As an example, scholarly peer review may refer to the process of subjecting an author's work, research, or ideas to the scrutiny of others who are experts in the same field, before the author's writings are published. The peer review may assist the editor in deciding whether to accept, accept with revisions, or reject a written article. Peer review may be used to maintain quality standards, improve article accuracy, and provide credibility for the article.

There may be different types of peer review, e.g., including blind review (e.g., in which the identity of one or more of the peer reviewer, the author, and/or the editor is kept anonymous) or open review (e.g., in which the reviewer and author are known to each other during the peer review process). The open peer review may include publication of the reviewers' names on the published article, publication of a peer review report, etc.

Providing editing comments and peer review of a written article can be a time consuming task for the peer reviewer. The length of time involved may persuade the peer reviewer to decline an opportunity to perform peer review or to limit the amount of peer review that the expert performs. The present disclosure provides peer review tools that improve the efficiency and accuracy of peer review through an improved peer review user interface and editorial system.

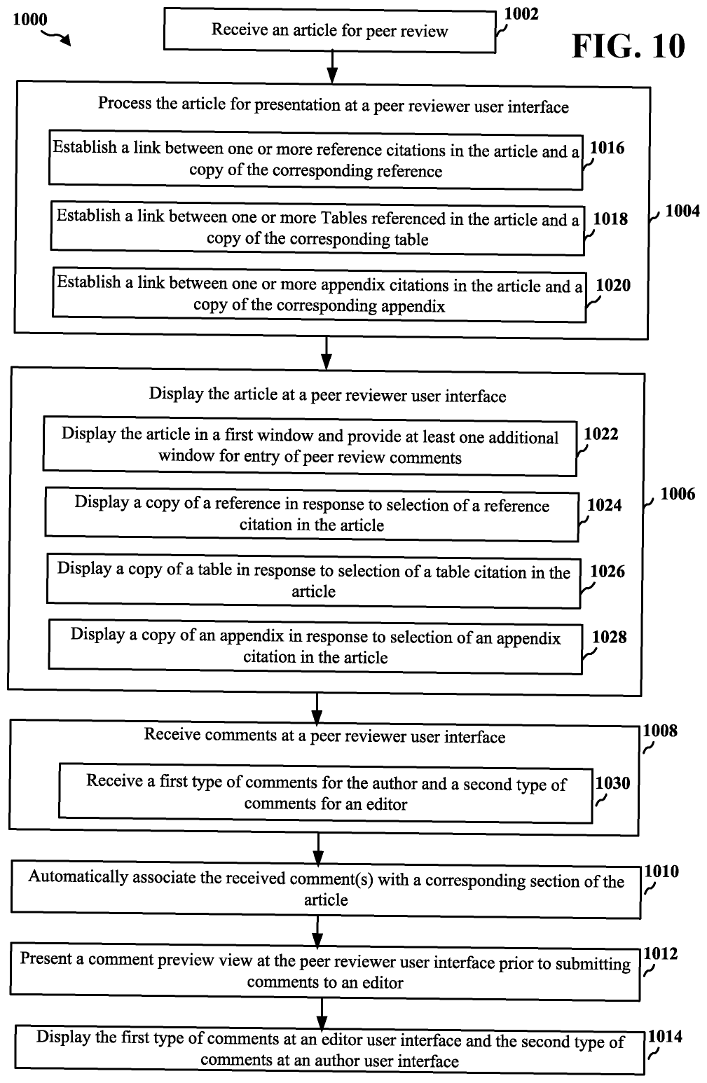

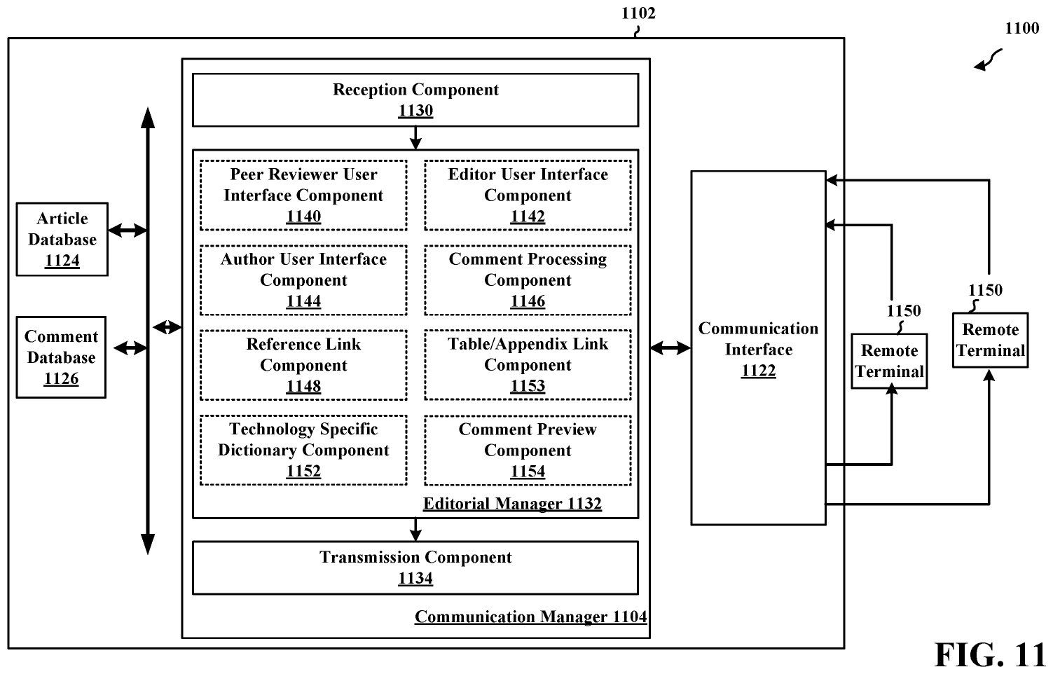

At 112, the editorial manager component 104 processes the draft article for review. An article may include written description with the author's findings, opinions, propositions, etc. The written article may cite to various references to support the author's findings. The article may include tables with data about the author's research or with other information relating to the article. The article may cite to one or more appendices. As described in more detail in connection with 1016, 1018, and 1020 in FIG. 10, the processing that occurs at 112 may include obtaining and storing a copy of any cited references, tables, appendices, etc. and creating a link between the reference in text of the written article and the stored copy. For example, the system may receive a copy of the cited references, tables, appendices, through user entry. In some aspects, an author may submit a copy of each reference, table, appendix, etc. cited in the author's article. The author may submit the copy in any of various forms, e.g., electronically via email or other message system, at a user interface that automatically stores the copies at a storage system, such as the article database 1124 illustrated in FIG. 11. In other aspects, a user at the editorial system may input a copy of each reference, table, appendix cited in a particular article. The user may scan or otherwise enter a copy provided by the author, and the system may store a copy at a storage database, such as 1124. In other aspects, the system may collect the reference(s), table(s), and/or appendix(es) in an automated manner. For example, upon receipt of a document, the system may identify cited references, tables, and appendices that are cited in the document. The system may automatically store a copy of any information provided directly in the document, such as tables or attached appendices at a database such as 1124. The system may automatically perform a search or otherwise obtain a copy of third party references. For example, the system may obtain copies via the internet in an automated manner and may store the automatically obtained copies in the database 1124.

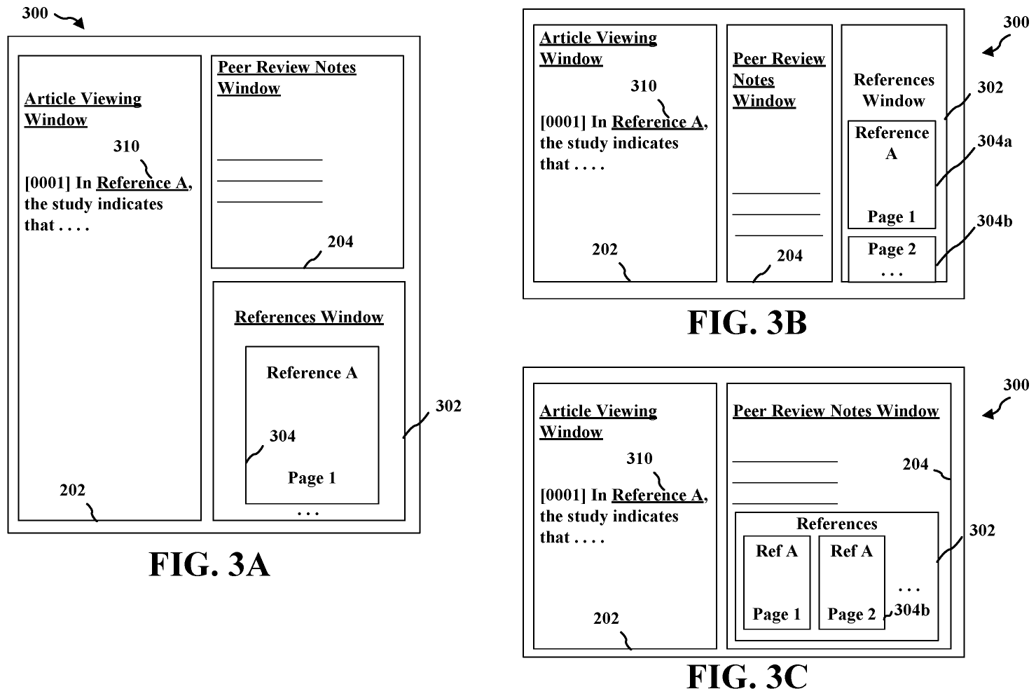

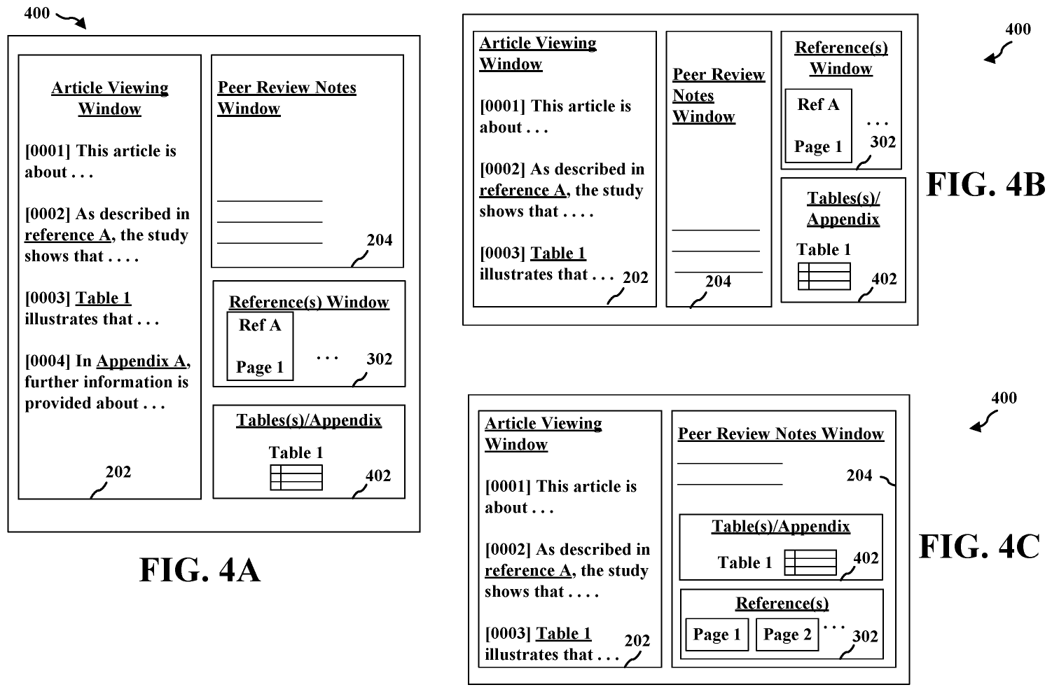

Along with obtaining and storing a copy of the references, tables, and/or appendices, the editorial manager component 104 also creates a version of the document for review (e.g., the article for peer review) that includes user selectable links at each citation to a corresponding reference, table, or appendix. Upon receipt of a user selection of the selectable link, the linked copy of the corresponding reference, table, or appendix is displayed to the reviewer at the user interface. The aspects of the user selectable link are described in additional detail in connection with FIGS. 3A-3C and 4A-4C.

As an example, the written article may cite to a reference in various ways, e.g., by the name of the reference, in a footnote, through the use of the term “Id.,” among other examples. At each instance that a reference is cited, a selectable option may be provided that links the instance to the copy of the reference. Similar links may be provided to each reference to a table, an appendix, and other referenced material.

At 114, the article for review may be provided to a peer reviewer user interface 106a. FIG. 1 illustrates that the article for review 116 may also be provided to an additional peer reviewer user interface 106b for review by another peer expert in the technical field. Although only two peer reviewer user interfaces are illustrated in FIG. 1 in order to illustrate the concept, the article may be provided to any number of experts for peer review according to the aspects presented herein.

As illustrated at 118, and similarly at 120, the article may be presented for review at the corresponding peer reviewer user interface 106a or 106b. FIGS. 2A-7 illustrate various aspects of a peer reviewer user interface, any combination of which may be used to present the article at the peer reviewer user interface. For example, as illustrated in FIGS. 2A and 2B, the peer reviewer user interface 106a may display the article to the peer reviewer in a first portion (e.g., 202) of the user interface 200 and may provide, e.g., display, an entry component (e.g., at 204 including 208 and/or 210) configured to receive the peer reviewer's comments, notes, and recommendations about the article. In some aspects, the article may be displayed in a first window (e.g., 202), and the comments may be received in a second window (e.g., 204). In FIG. 2A, the two portions are illustrated as being adjacent to each other. In some aspects, the comment portion (e.g., 204) may overlap, or may be resized to overlap the portion (e.g., 202). Also, although FIGS. 2A and 2B illustrate two windows that are arranged horizontally beside each other, the windows may be provided in a vertical arrangement, e.g., with the article displayed in an upper portion of the user interface and the comment entry component displayed in a lower portion of the user interface, or vice versa.

The peer reviewer user interface may automatically associate peer review comments with a section of the article. For example, as the peer reviewer reviews the article displayed at 202, the user interface may receive a selection of a portion of the article. For example, the peer reviewer may highlight, select, click on, or otherwise indicate a part of the article in the article viewing window (e.g., 202). Then, the peer reviewer may enter a comment about that section of the article in the comment window (e.g., 204). The peer reviewer may enter the comment by typing a comment, through dictation, etc. The comment may be automatically linked to the indicated section of the article, e.g., without the peer reviewer typing or dictating the specific section. For example, the selection of the relevant part of the article may be automatically associated with the peer reviewer's comment. The association may be stored so that when comments are provided to the editor and/or author, the relevant part of the article is indicated along with the comment.

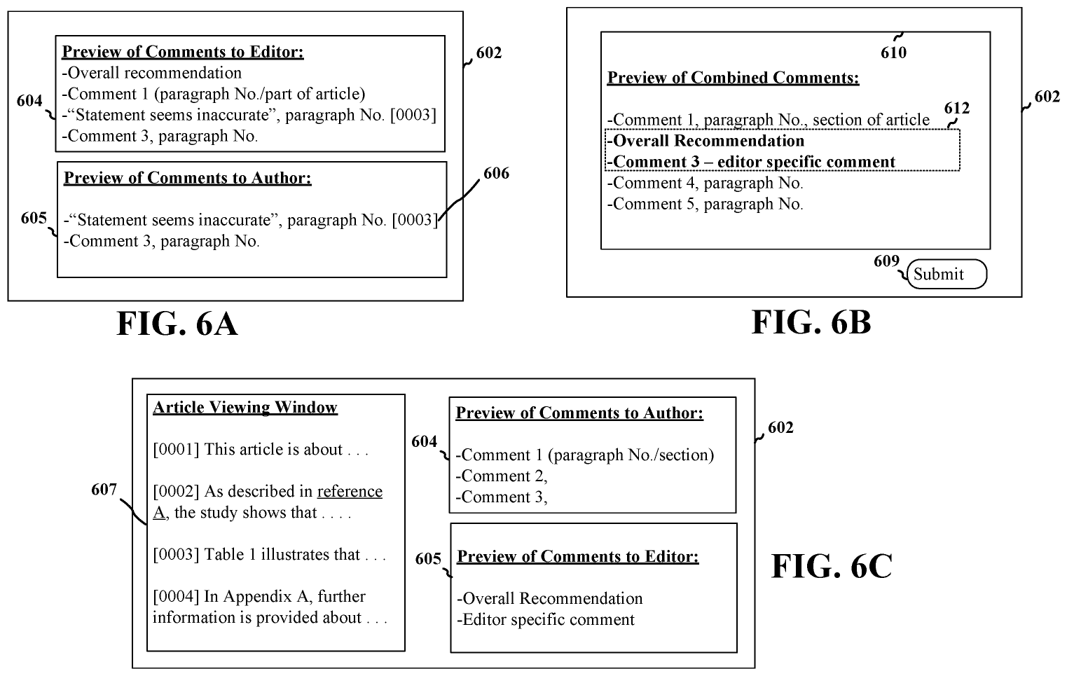

As one non-limiting example, the peer reviewer user interface may allow the peer reviewer to highlight and/or select a portion of the text of the article, as shown at 206. The peer reviewer may select/highlight the portion by clicking on the section and moving a cursor, e.g., by movement of a mouse or other tracking component, across the portion of the article to be selected. A comment that is entered in the other window while the portion 206 is highlighted will automatically be associated with, e.g., have its association stored, the indicated portion 206. In another example, the peer reviewer may click, touch, or otherwise indicate a particular spot in the article to create the link with the comment. FIG. 2A illustrates an example in which the peer reviewer entered the comment “Statement seems inaccurate” 208 in the second window while the language about Table 1 is highlighted, as shown at 206. The association between the comment and the paragraph number (e.g., paragraph [0003]), the particular sentence, the table, etc. may be stored in connection with the comment. Then, when the comments are provided to the editor and/or author, a notation of the highlighted portion of the article may also be presented. For example, FIG. 6A illustrates a user interface that shows a preview of the comments and shows at 606 that the peer review comment “statement seems inaccurate” includes “paragraph no. [0003]” indicating the portion of the article to which the comment is directed. The use of a paragraph number is merely an example. In other aspects, the particular sentence, the page and line number, a copy of the highlighted text, etc. may be provided with the comment in order to indicate the portion of the article selected by the peer review when entering the comment.

By enabling the peer reviewer to simultaneously view the article and enter comments, the peer reviewer user interface 106a or 106b enables the peer reviewer to enter comments more efficiently and may encourage the peer reviewer to provide additional comments, which may provide for more accurate peer review. As well, by allowing the peer reviewer to indicate a portion of the article when entering the comments, the peer reviewer user interface 106a or 106b reduces the amount of information that the peer reviewer needs to provide in their comments/notes, which enables the peer reviewer to review and comment more quickly and in a more efficient manner.

The peer reviewer may enter comments intended for different parties, or may enter different types of comments at the user interface 106a. The peer reviewer user interface 106a may receive the entry of comments, at 122, and the peer reviewer user interface 106b may receive user comments at 124. The entry component at the peer reviewer user interface may provide separate entry sections for entry of different types of comments. As illustrated in FIG. 2A, a first entry component 210 may receive peer reviewer comments that are directed to the author, and a second entry component 212 may receive peer reviewer comments that are directed to the editor, or that are not intended for the author. The peer reviewer may enter their comments in a 210 or 212 depending on the party that is intended to receive the comment. FIG. 2B illustrates an example in which a single entry component 214 may be provided, and a button, drop down menu, or other selectable option is provided to the peer reviewer to designate the party to which the comment is directed. For example, when entering the comment “statement seems inaccurate” into the single entry component 214, the peer reviewer may select “author” or “both” by clicking, touching, or otherwise selecting a button labeled with the intended part, by selecting the intended party from a drop down menu, etc. For example, when a comment is entered, the selectable button or drop down menu may automatically be presented to the peer reviewer until a selection is made indicating whether the comment is directed to the editor, the editor, both, etc. In some aspects, a selection may be presented that the note is intended for the peer reviewer themselves, e.g., in order to allow them to create notes/comments for their own notes.

When the comments (e.g., 123) are received at the editorial manager component 104 in FIG. 1, the two types of comments may be received separately or may be designated separately for the editor and the author. As illustrated at 126, the peer reviewer comments may be processed at 126 in order to be provided to the editor and/or author, based on the manner in which the comments were entered at the peer reviewer user interface 106a. For example, the comments entered at 210 may be processed for delivery to the author, at 132. Similarly, the comments entered at 214 and designated for the author may be delivered to the author, at 132. The comments entered at 212, or at 214 with the designation for editor, may be delivered to the editor, at 128. In some aspects, all of the entered comments, or the comments designated for the editor/author, may be processed at 126 and delivered to/displayed at the editor user interface 103. The comments may be processed to be presented to the editor at a user interface, e.g., at 103. The comments may be processed to be sent to the editor in an electronic message, such as an email message, a portal message, a text message, or some other form of electronic notification. The comments may be processed to be presented to the editor in a document that summarizes, or presents, all of the comments, edits, etc. entered by the one or more reviewers.

A subset of the comments, e.g., only those designated for the author, may be provided to the author, at 132. The comments may be processed to be presented to the author at a user interface, e.g., at the author device 102. The comments may be processed to be sent to the author in an electronic message, such as an email message, a text message, or some other form of electronic notification. The comments may be processed to be presented to the author in a document that summarizes, or presents, the comments, edits, etc. entered by the one or more reviewers and/or an editor. For example, the editor may enter additional comments for the author, at 130. In some aspects, the processing of the comments, at 126 may include combining the subset of the comments 123 for the author from the peer reviewer user interface 106a and at least a portion of the comments 130 from the editor to send to the author at 132. As well, the processing, at 126, may include combining comments for the author that are received from multiple peer reviewer user interfaces, e.g., 106a, 106b, etc.

The author, or similarly, the editor, may receive multiple documents, e.g., one for each peer reviewer, or may receive a combined document that includes the combined comments from multiple peer reviewers. In a combined document, the comments may be presented separately for each peer reviewer, e.g., a first set of comments that includes the entire set of comments entered for the author/editor by a first peer reviewer followed by a second set of comments entered for the author/editor by a second peer reviewer, and so forth for any number of peer reviewers. Additionally, or alternately, the comments may be presented to the author/editor in a combined manner that groups comments by section of the article, by type of comment, or by another type of grouping. For example, the comments that each of the peer reviewers entered for an introduction may be presented together, the comments that each of the peer reviewers entered for the conclusion may be grouped together, the comments that each of the peer reviewers entered for a particular paragraph, a particular page, a particular reference, etc. may be grouped together. The grouping of the comments may enable the author/editor to easily detect a pattern of comments and to apply the comments in revising the corresponding section of the article or in making determinations about whether to publish the article.

As illustrated at 134, the author may edit the article based on the comments from the peer reviewer(s) and/or the editor. The author may submit a revision of the article, at 136. Although not illustrated, the revised article may be provided to the peer reviewer(s) via the peer reviewer user interfaces 106a or 106b for additional review/comments. For example, any of the aspects described in connection with 114-136 may be repeated over any number of iterations until the revised article is either deemed ready for publication, e.g., at 138, and/or until a determination is made not to publish the article.

The peer reviewer may enter different types of comments for the editor than for the author. For example, the peer reviewer may enter a recommendation about whether or not to publish the article that is intended for the editor and not for the author, e.g., recommend publication without changes, recommend publication with changes, recommend rejection with modifications, or recommend rejection without modification. In some aspects, the peer reviewer user interface may present a selectable button or drop down menu to receive this recommendation from the peer reviewer. Additionally, or alternatively, the peer reviewer may enter more candid comments that are intended for the editor and not the author. As an example, the peer reviewer may enter comments for the editor such as “the author should know that . . . ” “the article is full of grammatical errors,” etc. In contrast, the comments for the author may be more directed to editing of the article, such as correcting spelling/grammar mistakes, correcting citations to references, adding comments for the author to consider in their revision of the article. By enabling the peer reviewer to create separate sets of comments (e.g., for the editor/author) at the same time and/or in the same user interface component, as described in connection with FIG. 2A or 2B, the peer reviewer user interface described herein enables the peer reviewer to provide comments in a more efficient manner. As well, by enabling the peer reviewer to designate comments for the editor in a simplified manner, the user interface may increase the likelihood of the peer reviewer entering candid comments for the editor. Such candid comments may enable the editor in determining whether to publish an article and in working with the author to improve the quality of the article prior to publication. The peer reviewer user interface may also provide a visual indication to the peer reviewer about the comments designated for the editor versus the author. In FIG. 2A, the comments may be shown in different portions of the user interface so that the peer reviewer can visually ascertain the party to which the comments will be directed. In FIG. 2B, a different type of visual indicator may be provided. For example, the comments directed to the editor may be shown in a first color of text, and the comments directed to the author may be shown in a second, different color of text. The comments to the editor may be highlighted in contrast to the comments to the author, or vice versa. The comments to the editor may be shown in a different font, a different font size, italics, bold, etc. in contrast to the style of the comments for the author, or vice versa. This different visual representation of the comments at the peer reviewer user interface may enable the peer reviewer to easily see which comments will be directed to the author and may help to avoid sending comments to the author that are intended for the editor and not the author.

In some aspects, the peer reviewer user interface 106a or 106b may be configured to provide the peer reviewer with a preview of the comments before submitting the comments to the editorial manager component 104. FIGS. 6A-6C illustrate various example aspects for a peer reviewer user interface 602 that displays a preview of comments to the peer reviewer before submission to the editor/author. As an example, in FIGS. 6A and 6B, the preview of the comments to the editor may be shown separately (at 604) from the preview of the comments for the author (at 605). The preview may show the comment entered by the peer reviewer, as described in connection with FIGS. 2A and 2B, and may also show the corresponding section of the article to which the comment pertains, e.g., as described in connection with FIGS. 2A and 2B. For example, the preview may show the paragraph number, page, line number, section, or copy of the text from the article that is associated with the comment. As described in connection with FIGS. 2A and 2B, the peer reviewer may have entered only the comment, and the paragraph no, page number, line number, section, etc. may be automatically associated with the comment. Therefore, the preview in FIG. 6A may show a preview of the comment, and the portion of the article that the editorial system has automatically linked/associated to the comment. FIG. 6A also illustrates that the comments to the author may be a subset of the comments to the editor. As shown in FIG. 6A, in some aspects, the preview may show the superset of comments that will be directed to the editor. In other aspects, as shown in FIG. 6C, the preview of comments to the editor may include only those comments that are specific to the editor and not the author. However, when the comments are submitted from the peer reviewer to the editorial manager component 104, and further provided to the editor user interface 103, both the comments shown at 604 and 605 in FIG. 6 may be provided to the editor. FIGS. 6A and 6B illustrate examples in which the preview may be shown separately from the article.

FIG. 6C illustrates an example in which the user interface may display a copy of the article, at 607, simultaneously with the preview of the comments to the editor/author. The display of the article along with the preview of the comments may enable the peer reviewer to quickly and easily review their comments before submitting their comments to the editorial manager component 104. In some aspects, the preview of the comments, at 604 or 605, may be linked to the display of the article, at 607. For example, if the peer reviewer selects a particular comment, the view of the article, at 607, may automatically move to display the corresponding section of the article that corresponds to the selected comment. In some aspects, the preview at the user interface may allow the peer reviewer to change/edit the comments. Once the peer reviewer is ready to submit the comments, the peer reviewer may submit the comments via the user interface, such as by selecting a submit button 609.

FIG. 6B illustrates an example in which the comments for both the editor and the author may be shown in a combined preview 610. The combined preview may visually indicate the comments that are specific to the editor in contrast to those that are intended for the author. FIG. 6B shows a visual indicator 612 that may surround the comments that are intended for the editor and not the author. As described in connection with the entry of the comments, the comments directed to the editor may be shown in a first color of text, and the comments directed to the author may be shown in a second, different color of text. The comments to the editor may be highlighted in contrast to the comments to the author, or vice versa. The comments to the editor may be shown in a different font, a different font size, italics, bold, etc. in contrast to the style of the comments for the author, or vice versa. This different visual representation of the comments at the peer reviewer user interface may enable the peer reviewer to easily review which comments will be directed to the author/editor before submitting the comments. The visual representation may help the peer reviewer to avoid sending comments to the author that are intended for the editor and not the author.

In addition to the display of the article and the entry component for receiving peer reviewer's comments, described in connection with FIGS. 2A and 2B, the peer reviewer user interface 300 may provide a display of one or more references cited in the article. For example, a window 302 may be provided at the user interface 300 that displays a copy of the reference corresponding to a particular citation in the article. For example, the window 202 displaying the article may include user selectable links for each of the reference citations in the article. As discussed in connection with 112 in FIG. 1, the user selectable link may be provided for each citation to the name of a reference, a footnote referring to a reference, another citation, such as the term “Id.”, etc. The link may be linked to a copy of the corresponding reference that is stored at a datable, such as database 1124. When the peer reviewer selects the selectable link, e.g., by clicking, touching, or otherwise selecting the citation, an indication may be sent from the user interface, e.g., which may be displayed at a remote user terminal, to a central editorial management system including the editorial manager component. In response to the indication, the corresponding copy of the reference may be accessed from the database 1124, which may be provided as a part of the editorial management system. The copy may then be provided for display at the corresponding peer reviewer user interface from which the indication was received. For example, a copy of the corresponding reference may be displayed in the window 302. FIG. 1 illustrates, at 119, that one or more instance of the user selection and the provision/display of the copy of the reference may occur as a part of presenting the article at the peer reviewer user interface 118. FIGS. 3A-3C illustrate various examples showing a user selectable link 310 for a citation to reference A. FIGS. 3A-3C illustrate the user selectable link using underlining. In some aspects, the ability to select the link may be visually indicated to the author in any combination of ways, such as via underlining, italics, contrasting text color, contrasting background color, highlighting, bold text, a visual button, etc. In other aspects, the user selectable link may not be visually indicated, and the reviewer may be aware of the ability to highlight, click on, or otherwise select any citation reference within the document in order to view a copy of the corresponding reference. There may be multiple instances of references to the same citation, and each instance may be linked to the copy of the reference that is stored in the database. As well, the document may have citations to multiple references, with each citation to each reference being provided as a user selectable link to the copy of the corresponding references that are stored in the database. FIGS. 3A-3C illustrate examples in which “Reference A” has been selected in the window 202 displaying the article, and the window 302 displays one or more pages of Reference A 304. Aspects that have already been described in connection with FIG. 2 are illustrated with the same reference numbers as in FIG. 2. For example, the peer reviewer user interface may display a particular portion of the reference, e.g., a page, corresponding to the citation. Alternatively, the peer reviewer user interface may display a first page of the reference, and may allow the peer reviewer to navigate through the pages of/content of the reference via the window 302. FIGS. 3B and 3C illustrate that multiple pages 304a, 304b of the reference may be displayed in the window 302. FIGS. 3A, 3B, and 3C illustrate that the window 302 may be placed in various positions within the user interface 300 and relative to the window 202 showing the article and the window 204 that receives entry of the peer reviewer comments. As shown in FIG. 3C, the reference may be displayed within a portion (e.g., 302) of the window 204 for receiving entry of the peer review comments. In some aspects, the user interface may provide a display as shown in FIGS. 2A and 2B until the peer reviewer selects a link for a reference citation in the display of the article. Upon selection of a reference citation, the window 302 may be automatically added to the display at the user interface. In some aspects, the peer reviewer may be able to close the window 302 upon completion of viewing the reference.

The user interface in FIGS. 3A-3C enables the peer reviewer to quickly view the cited references as the reviewer reviews the article displayed in the window 202. The ease of reviewing a cited reference during the review process and in the same user interface at which the peer reviewer views the article makes the peer review process more efficient by enabling the peer reviewer to review and verify information in the article in a quicker and simpler manner. By providing a more efficient tool for the peer reviewer to review the cited references, the user interface may also improve the accuracy of the peer review.

Similar to the window 302 that automatically displays a copy of the cited references, the user interface may provide a window 402 that displays a table/appendix referenced in the article. As described in connection with FIGS. 3A-3C, the display of the article, at 202, may include user selectable references to each table, appendix, etc. described in the application. When the peer reviewer selects the selectable link, e.g., by clicking, touching, or otherwise selecting the citation to the table/appendix, a copy of the corresponding table/appendix may be displayed in the window 402. FIGS. 4A-4C illustrate examples in which “Table 1” has been selected in the window 202 displaying the article, and the window 402 displays a copy of Table 1. Aspects that have already been described in connection with FIG. 2 and FIG. 3 are illustrated with the same reference numbers as in FIGS. 2 and 3. FIGS. 4A, 4B, and 4C illustrate that the window 402 may be placed in various positions within the user interface 400 and relative to the window 202 showing the article, the window 204 that receives entry of the peer reviewer comments, and/or the window 302 displaying a cited reference. As shown in FIG. 4C, the reference may be displayed within a portion (e.g., 402) of the window 204 for receiving entry of the peer review comments. In some aspects, the user interface may provide a display as shown in FIGS. 2A-2B or 3A-3C until the peer reviewer selects a link for a table/appendix in the display of the article. Upon selection of the link, the window 402 may be automatically added to the display at the user interface 400. In some aspects, the peer reviewer may be able to close the window 402 upon completion of viewing the reference.

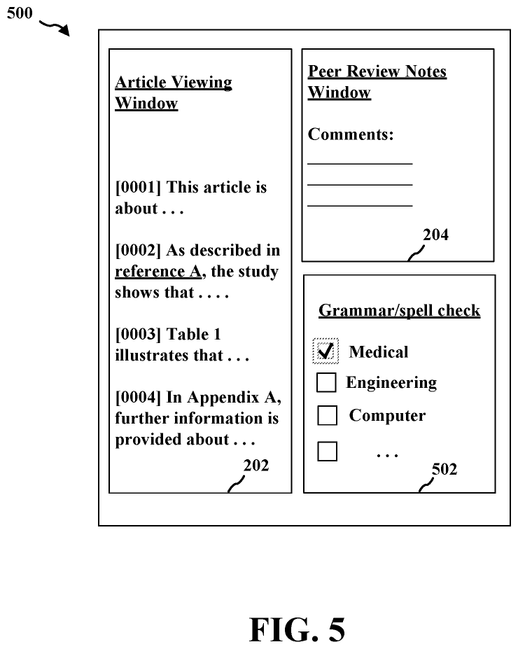

In some aspects, a part of the peer review process may involve a review of the spelling and grammar of the article in addition to a review of the technical aspects of the article. While the peer review may run a spell check option, many words that are less common outside of a technical field may be indicated as being misspelled or grammatically incorrect. The peer reviewer user interface 106a or 106b may provide a selectable option to run a spell check and/or a grammar check of the article. Alternatively, the display of the article in the window 202 may automatically display potential spelling/grammatical errors to highlight such sections for additional review by the peer reviewer. As shown in FIG. 5, the user interface 500 may provide options, at 502, for the peer reviewer to perform a spelling check/grammar check that is specific to a particular technical field. For example, if the peer reviewer selects “medical” as shown in FIG. 5, the tool that runs the spelling check/grammar check or that automatically highlights potential spelling/grammar issues in the display of the article may apply a dictionary with terms from the medical field, e.g., including medical terms, medical acronyms, common phrasing in the medical field, etc. The tool may provide the peer reviewer with sub-options for particular medical fields, in some examples. Although the example in FIG. 5 only illustrates the options to select medical, engineering, and computer, the options of different technical fields may include a comprehensive list of different scientific/professional fields. Among other examples, the technical field options may include any of mathematics, physics, geology, astronomy, medical, sociology, psychology, biology, chemistry, economics, computer, agriculture, education, sociology, political science, etc. In some aspects, the editor may select the particular technical field, and the spelling check/grammar check tool may apply a dictionary/grammar rules for the technical field selected by the editor when displaying the article at the peer reviewer user interface.

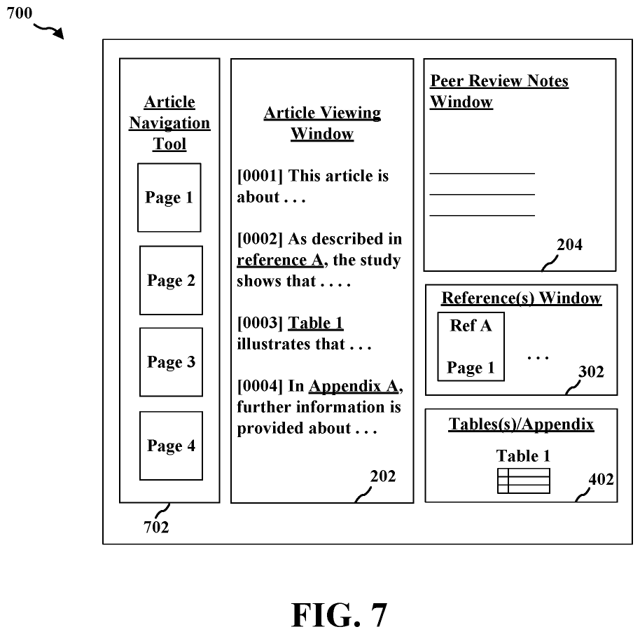

FIG. 7 illustrates an example user interface 700 that illustrates that in addition to the window 202 displaying the article for review, and any combination of the window 204 to receive entry of the peer review comments, window 302 that displays a copy of a reference cited in the article, and/or window 402 that displays a copy of a table/appendix in the article, the user interface 500 may further include a window/feature for an article navigation tool 702 that assists the peer reviewer in navigating the view of the articular provided in the window 202. For example, the article navigation tool 702 may illustrate selectable icons for the different pages of the article. When the peer reviewer selects the icon for a particular page, the corresponding page is displayed in the window 202. In some aspects, the article may be displayed, at 202, as a PDF version of the article, or a non-editable version of the article.

The peer reviewer user interface 106a or 106b may include any combination of the aspects described in connection with FIGS. 2A-7. Aspects from different figures may be combined together in the user interface. As well, although examples have been provided for the example of peer review in order to illustrate the concept, the aspects may be applied to a document review system for review by editors or other parties that are not part of a peer review process. For example, any combination of the example aspects described in connection with the peer reviewer user interface of any of FIGS. 1-7 may be applied for an editor user interface or a reviewer user interface. For example, an editing system may enable review and editing of documents by a single party rather than peer review by one or more peer reviewers that is provided to a third party editor system. In some aspects, an editing system may enable a user to upload an article at the user interface that they select for review. The editing system may process the document for display to the reviewer according to any of the aspects described in connection with FIGS. 2A-7. As well, the user may designate a recipient for the comments. For example, the user may enter an email address or other identifying information for the intended recipient of the user's comments on their review of the document. When the user submits their comments, the editing system may send the comments to the indicated recipient.

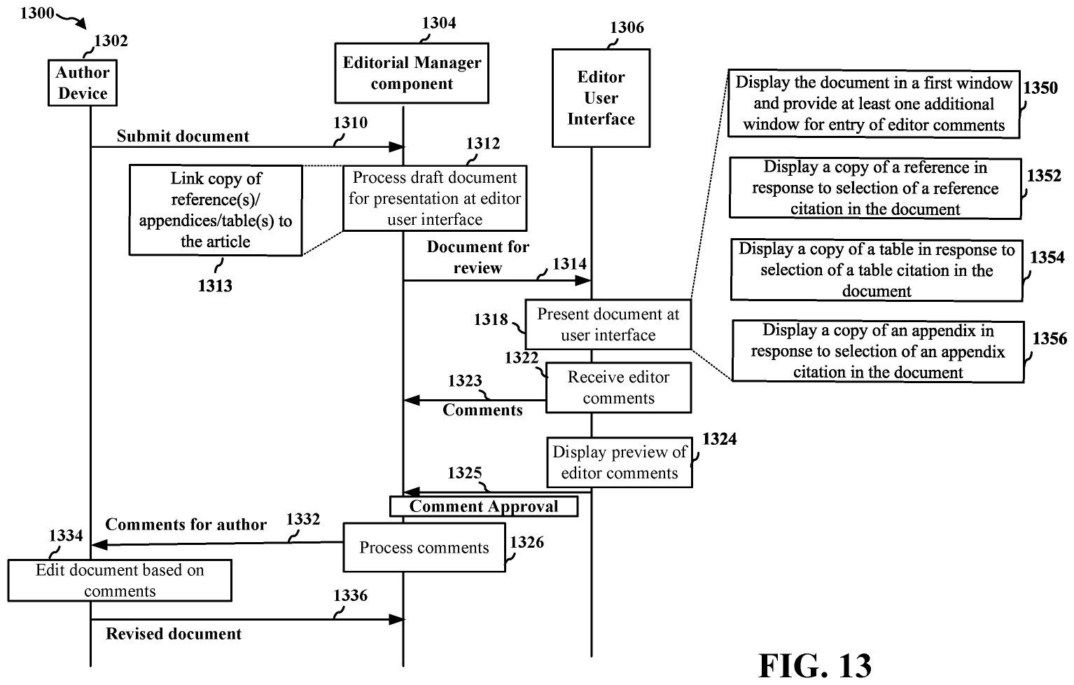

FIG. 13 illustrates an example information flow 1300 illustrating such an example. An information flow may include any combination of the aspects illustrated and/or described in connection with FIG. 13, and may incorporate aspects described in connection with FIGS. 1-12. In 1302, an author device 1302 may submit a document for review. The document 1310 may be input into the editorial manager component 1304 in any of various ways. For example, the document 1310 may be input at an entry component of a user interface, e.g., at the author device 1302, at an editorial management system that includes the editorial manager component 1304, via the editor user interface 1306, etc. In some examples, the document 1310 may be uploaded at a user interface that is remote from the editorial manager component 1304, and may be presented for review to a terminal that is remote from the editorial manager component 1304, via a communication interface, e.g., as described in connection with the example aspects of FIG. 8. In some aspects, the editorial manager component 1304 may be comprised in a local computer system at which the editor user interface is presented, in some aspects. In other aspects, the editorial manager may be part of a central processing system, and the editor user interface may be provided at a remote terminal, such as illustrated in connection with FIG. 8.

At 1312, the editorial manager component 1304 may process the document for presentation at an editor user interface. The processing may include any of the aspects described in connection with 112 in FIG. 1 and/or 1004 in FIG. 10, for example. As illustrated at 1313, the processing may include linking a copy of one or more references to their corresponding citations within the document, a copy of one or more tables to their corresponding citations within the document, and/or a copy of one or more appendices to their corresponding citations within the document.

At 1314, the document, as processed at 1312, is provided to an editor user interface 1306 for presentation to a user. At 1318, the document is presented at the editor user interface 1306. The presentation of the document for review at the user interface may include any of the aspects described in connection with 118 in FIG. 1, the examples in any of FIGS. 2A-7, the display described at 1006 in FIG. 10, and/or the communication aspects described in connection with FIG. 8. For example, as illustrated at 1350, the user interface may display the document in a first window and provide at least one additional window for receiving the entry of user comments, e.g., as described in connection with FIGS. 2A and 2B. As illustrated at 1352, the user interface may provide a link within the display of the document to citations of one or more references. The link may provide a selectable feature, which upon selection, triggers the user interface to automatically display a linked copy of the corresponding reference, e.g., as described in connection with any of FIGS. 3A-3C. As illustrated at 1354, the user interface may provide a link within the display of the document to citations of one or more tables. The link may provide a selectable feature, which upon selection, triggers the user interface to automatically display a linked copy of the corresponding table, e.g., as described in connection with any of FIGS. 4A-4C. As illustrated at 1356, the user interface may provide a link within the display of the document to citations of one or more appendices. The link may provide a selectable feature, which upon selection, triggers the user interface to automatically display a linked copy of the corresponding appendices, e.g., as described in connection with any of FIGS. 4A-4C.

At 1324, the user interface 1306 may receive entry of editor comments 1323 at an entry component within the user interface, at 1322. The receipt of the editor comments may include any of the aspects described in connection with 122 and/or 123 in FIG. 1, FIGS. 2A-2B, and/or 1008 in FIG. 10.

In some aspects, the user interface may display a preview of the entered comments, e.g., before they are provided to another part, such as the author. The preview may include any of the aspects described in connection with 4A-4C and/or 1012 in FIG. 10. In some aspects, the editor may enter a subset of comments intended for a separate part, e.g., including a personal record of comments for the editor themselves. In other aspects, the preview may present all of the comments for preview before being sent to the author. In some aspects, the system may wait to receive an approval 1325 of the comments from the editor user interface 1306 before processing the comments, at 1326, and/or providing the comments to the author at 1332. The comments may be processed to be presented to the author at a user interface. The comments may be processed to be sent to the author in an electronic message, such as an email message, a text message, or some other form of electronic notification. The comments may be processed to be presented to the author in a document that summarizes, or presents, all of the comments, edits, etc. entered by the editor at the editor user interface 1306.

The author may review the comments. In some aspects, the comments may be presented to the author at an author user interface. The author may edit the document, at 1334 based on the reviewer's comments. In some aspects, the author may input a revised version of the document for further review, at 1336. The aspects of 1312-1336 may be performed in multiple iterations, e.g., until a stopping point is reached. The stopping point may be based on the editor having no additional comments, and/or the author not submitting a revised draft.

In some examples, the editor user interface 1306 may be used by a teacher reviewing student papers, a professor editing a student's paper prior to external submission, etc. The system described in connection with FIG. 13 may be used in various settings in which a user may review a draft document having citations, tables, and/or appendices in order to provide editorial comments, reviewer comments, grading, technical analysis, etc.

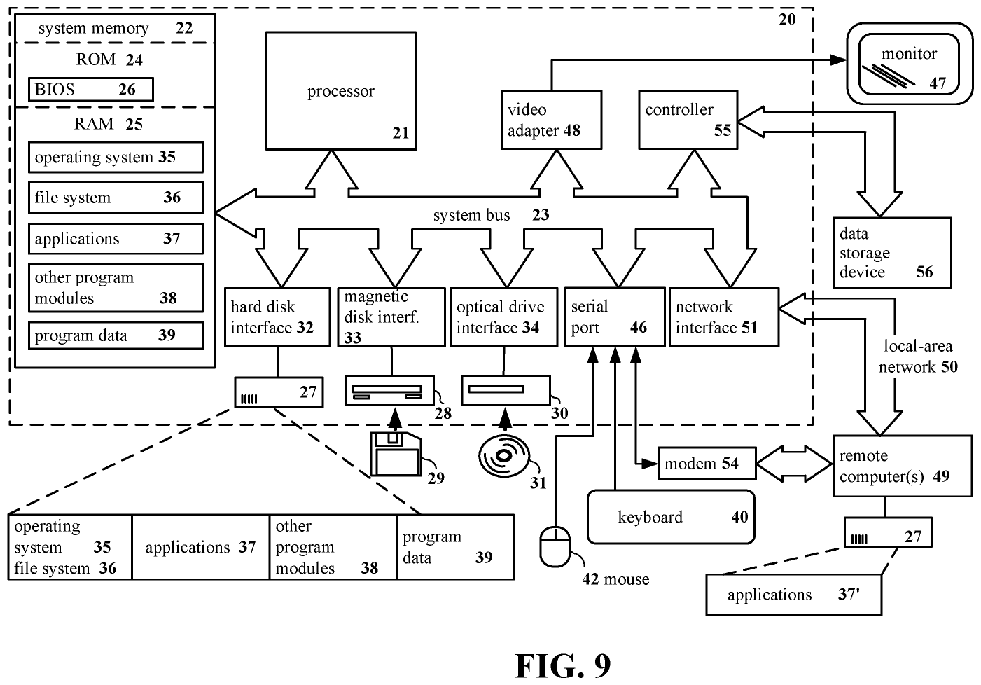

The aspects illustrated in connection with FIGS. 1-7 and 13 may be implemented using any of the system components of a communication system, as described in connection with FIG. 8; a computer system 20, as described in connection with FIG. 9; and/or an editorial management system 1102, as described in connection with FIG. 11.

FIG. 8 is a block diagram of various example system components, in accordance with aspects presented herein. FIG. 8 shows a communication system 800 usable in accordance with the aspects presented herein. The communication system 800 includes one or more accessors 808a, 808b, 808c, 808d (also referred to interchangeably herein as one or more “users”) and one or more terminals 806a, 806b, 806c, 806d. As described herein, for example, data may be input and/or accessed by accessors 808a, 808b, 808c, 808d via terminals 806a, 806b, 806c, 806d via a user interface. Information may be provided to the user interface over a network from an editorial management system 1102. The editorial management system may include any of the aspects described in connection with FIG. 11, and may be configured to exchange communication with various types of accessors 808a-d and/or various types of terminals 806a-d. For example, at least one of the accessors 808a-d may be a peer reviewer that access data about an article and enters/inputs data (e.g., comments) about the article via a peer reviewer user interface that is displayed at the user's terminal (e.g., corresponding terminal 806a-d). Another accessor 808a-d may be an editor that receives/inputs data about the article (e.g., receives peer reviewer comments, inputs editor comments, and/or exchanges messages with the author) via an editor user interface that is displayed at the editor's terminal. Another accessor 808a-d may be an author of the article that inputs/receives data about the article (e.g., peer review comments, editor comments, messages about the article, revisions of the article, etc.) via an author user interface. The terminals may include any combination of personal computers (PCs), minicomputers, mainframe computers, microcomputers, telephonic devices, smart devices, a tablet, a laptop, a wireless device such as personal digital assistants (“PDAs”) or other hand-held wireless device coupled to a server 804, such as a PC, minicomputer, mainframe computer, microcomputer, or other device having a processor and a repository for data and/or connection to a repository for data, via, for example, a network 802, such as the Internet or an intranet, and couplings 810a, 810b, 810c, 810d, and 812. The couplings 810a, 810b, 810c, 810d, and 812 may include, for example, any combination of wired, wireless, or fiberoptic links. In another aspect, the method and system presented herein operate in a stand-alone environment, such as on a single terminal.

FIG. 9 is a block diagram illustrating a computer system 20 on which aspects of systems and methods for review of documents may be implemented in accordance with an example aspect. It should be noted that the computer system 20 can correspond to the editorial management system 1102, an editorial manager component 104, a remote terminal 806a-d, and/or a computer system for providing a user interface including any of the aspects described in connection with FIGS. 2A-7.

As shown, the computer system 20 (which may be a personal computer or a server) includes a central processing unit 21, a system memory 22, and a system bus 23 connecting the various system components, including the memory associated with the central processing unit 21. As will be appreciated by those of ordinary skill in the art, the system bus 23 may comprise a bus memory or bus memory controller, a peripheral bus, and a local bus that is able to interact with any other bus architecture. The system memory may include ROM 24 and/or RAM 25. The basic input/output system (BIOS) 26 may store the basic procedures for transfer of information between elements of the computer system 20, such as those at the time of loading the operating system with the use of the ROM 24.

The computer system 20, may also comprise a hard disk 27 for reading and writing data, a magnetic disk drive 28 for reading and writing on removable magnetic disks 29, and an optical drive 30 for reading and writing removable optical disks 31, such as CD-ROM, DVD-ROM and other optical media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the computer system 20.

An example aspect comprises a system that uses a hard disk 27, a removable magnetic disk 29 and a removable optical disk 31 connected to the system bus 23 via the controller 55. It will be understood by those of ordinary skill in the art that any type of media 56 that is able to store data in a form readable by a computer (solid state drives, flash memory cards, digital disks, RAM) and so on) may also be utilized.

The computer system 20 has a file system 36, in which the operating system 35, may be stored, as well as additional program applications 37, other program modules 38, and program data 39. A user of the computer system 20 may enter commands and information using keyboard 40, mouse 42, or any other input device known to those of ordinary skill in the art, such as, but not limited to, a microphone, joystick, game controller, scanner, etc. Such input devices typically plug into the computer system 20 through a serial port 46, which in turn is connected to the system bus, but those of ordinary skill in the art will appreciate that input devices may be also be connected in other ways, such as, without limitation, via a parallel port, a game port, or a universal serial bus (USB). A monitor 47 or other type of display device may also be connected to the system bus 23 across an interface, such as a video adapter 48. In addition to the monitor 47, the personal computer may be equipped with other peripheral output devices (not shown), such as loudspeakers, a printer, etc.

Computer system 20 may operate in a network environment, using a network connection to one or more remote computers 49. The remote computer (or computers) 49 may be local computer workstations or servers comprising most or all of the elements in describing the nature of a computer system 20. Other devices may also be present in the computer network, such as, but not limited to, routers, network stations, peer devices or other network nodes.

Network connections can form a local-area computer network (LAN) 50 and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the computer system 20 may employ a modem 54 or other modules well known to those of ordinary skill in the art that enable communications with a wide-area computer network such as the Internet. The modem 54, which may be an internal or external device, may be connected to the system bus 23 by a serial port 46. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a general purpose computer (such as the one described in greater detail in FIG. 9, above). Accordingly, each module may be realized in a variety of suitable configurations, and should not be limited to any particular implementation shown herein.

FIG. 10 is a flowchart 1000 of a method of document editing. The method may be performed by an editing system (e.g., the system 1102). One or more of the aspects may be optional or may be applied in a different order than illustrated, in some aspects. A method may include any combination of the aspects illustrated and/or described in connection with FIG. 10. The method may provide a user interface that enables more efficient and accurate review of documents, e.g., peer review of a draft article for potential publication.

At 1002, the system receives a written document for review. For example, the system may include an editorial management system, e.g., as described in connection with FIG. 8 and/or FIG. 11. The written document may be received from the author, such as illustrated in FIG. 1. The written document may be received at a user interface, such as at a web site or portal. In other aspects, the written document may be received via email from an author and may be input by another party into the editing system. The written document may be a draft article for peer review, such as described in connection with the example peer review process in FIG. 1.

At 1004, the system processes the written document for review at a user interface. The processing of the written document may include any of the aspects described in connection with 112 in FIG. 1, for example. As a part of processing the written document for review at a user interface, the system may establish a link between one or more reference citations in the written document and a copy of a corresponding reference, e.g., as illustrated at 1016. In some aspects, as a part of processing the written document for review at a user interface, the system may establish a link between one or more citations to a table in the written document and a copy of a corresponding table, e.g., as illustrated at 1018. In some aspects, as a part of processing the written document for review at a user interface, the system may establish a link between one or more citations to an appendix in the written document and a copy of a corresponding appendix, e.g., as illustrated at 1020.

At 1006, the system displays the written document at a first portion of the user interface. The display may include any of the aspects described in connection with 118 in FIG. 1 or in any of the example user interfaces described in connection with FIGS. 2A-7, for example. For example, the system may display the article in a first window and provide at least one additional window for entry of peer review comments, e.g., as illustrated at 1022. For example, the system may receive a selection of a citation in the written document at the first portion of the user interface and display a copy of a corresponding reference, in response to the selection, as illustrated at 1024, e.g., as described in connection with any of FIGS. 3A-3C. In some aspects, the system may receive a selection of a citation in the written document at the first portion of the user interface display a copy of a corresponding table, in response to the selection, as illustrated at 1026, e.g., as described in connection with any of FIGS. 4A-4C. In some aspects, the system may receive a selection of a citation in the written document at the first portion of the user interface and display a copy of a corresponding appendix in response to the selection, as illustrated at 1028, e.g., as described in connection with any of FIGS. 4A-4C.

At 1008, the system receives one or more comments about the written document at a second portion of the user interface. In some aspects, the system may receive a first type of comments for the author and a second type of comments for an editor, e.g., as illustrated at 1030. The reception may include any of the aspects described in connection with 122 in FIG. 1 or in connection with any of the example user interfaces described in connection with FIGS. 2A-7, for example.

As illustrated at 1010, the system may automatically associate each of the one or more comments entered at the second portion of the user interface with a portion of the written document selected at the first portion of the user interface.

At 1012, the system may display a preview of the entered comments at the user interface prior to submission of the comments to the editing system. The one or more comments about the written document may include a first type of comments and a second type of comments, e.g., as described in connection with any of FIG. 1 and FIGS. 2A-2B, and 6A-6C. The system may visually display the first type of comments with a first format and display the second type of comments with a second format.

As an example, the user interface may comprise a peer reviewer user interface, and the one or more comments about the written document may include a first type of comments for an editor and a second type of comments for an author. As illustrated at 1014, the system may display at least the first type of comments at an editor user interface and provide the second type of comments to the author. The display/provision of the multiple types of comments may include any of the aspects described in connection with 123, 126, 128, 130, or 132 of FIG. 1, FIGS. 2A-2B, and/or FIGS. 6A-6C.

The method in FIG. 10 may further include any of the aspects described in connection with FIG. 1-9, 11, or 12.

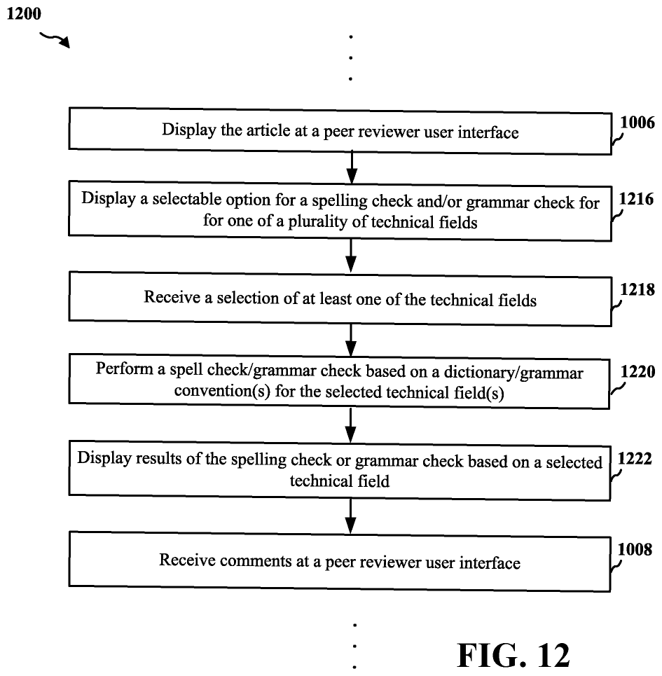

FIG. 12 is a flowchart 1200 of a method of document editing. The method may be performed by an editing system (e.g., the system 1102). In some aspects, the method of the flowchart 1200 may be performed in connection with the method in FIG. 10. One or more of the aspects may be optional or may be applied in a different order than illustrated, in some aspects. A method may include any combination of the aspects illustrated and/or described in connection with FIG. 12. For example, in connection with or following the display of the article at a user interface (e.g., a peer reviewer user interface), the system may display a selectable option for a spelling check or grammar check for a plurality of technical fields, e.g., at 1216. For example, FIG. 5 illustrates an example user interface with a selectable option for a grammar/spell check based on a particular technical field.

At 1218, the system may receive a selection of at least one of the plurality of technical fields, e.g., via the user interface. In some aspects, the user may select more than one technical field. FIG. 5 illustrates an example in which the “medical” technical field option is selected.

At 1220, in response to the selection received at 1218, the system performs a spell check and/or a grammar check based on the selected technical field(s). As an example, the system may include technical area specific terms, acronyms, phrases, grammar conventions, etc. along with ordinary (e.g., without being specific to a technical area) spelling and grammar rules to perform the spelling check/grammar check.

At 1222, the system displays results of the spelling check or grammar check, e.g., at the user interface based on a selected technical field. As illustrated in FIG. 12, the system may then proceed to receive user comments at a (peer reviewer) user interface, e.g., as described in connection with 1008 in FIG. 10. The order of 1216-1222 relative to the reception of comments, at 1008, may be in a different order than illustrated in FIG. 12. For example, the system may receive the comments, at 1008, prior to and/or after any of aspects 1216-1222.

FIG. 11 is a diagram 1100 illustrating an example of a hardware implementation for an editorial management system 1102. The system 1102 is a UE and includes a communication manager 1104 coupled to a communication interface 1122, which includes an editorial manger 1132. The communication manager 1104 communicates through the communication interface 1122 (which may include a transceiver) with one or more remote terminals 1150. The remote terminals may correspond to any of the access terminals 806a-d described in connection with FIG. 8. The communication manager 1104 may include a computer-readable medium/memory and/or one or more processors. The computer-readable medium/memory may be non-transitory. The communication manager 1104 is responsible for general processing, including the execution of software stored on the computer-readable medium/memory. The software, when executed by the communication manager 1104, causes the communication manager 1104 to perform the various functions described herein, e.g., including the aspects described in connection with FIG. 1, FIG. 10 and/or FIG. 11. The computer-readable medium/memory may also be used for storing data that is manipulated by the communication manager 1104 when executing software. The communication manager 1104 further includes a reception component 1130, an editorial manager 1132, and a transmission component 1134. The editorial manager 1132 may include the one or more illustrated components. The components within the editorial manager 1132 may be stored in the computer-readable medium/memory and/or configured as hardware within the processor of the communication manager 1104. The editorial management system 1102 further includes an article database 1124 that is configured to store one or more versions of an article that is being processed, or has been processed, for peer review, as described herein. The editorial management system 1102 may further include a comment database 1126 that is configured to store comments received from one or more peer reviewers, as well as other comments relevant to an article. The editorial management system 1102 may store an association between the comments stored in the comment database 1126 and a corresponding article. In some aspects, a single database may be provided, and the comments may be stored together with a corresponding article in the single database.

The reception component 1130 may be configured to receive an article for peer review, e.g., as described in connection with 1002 in FIG. 10. The editorial manager 1132 includes a peer reviewer user interface component 1140 that is configured to display the article at a peer reviewer user interface, e.g., as described in connection with 1006 and/or to receive entry of comments via the peer reviewer user interface, as described in connection with 1008 in FIG. 10. The editorial manager 1132 further includes an editor user interface component 1142 that is configured to present peer review comments at an editor user interface, e.g., as described in connection with 1014 in FIG. 10. The editorial manager 1132 further includes an author user interface component 1144 that that is configured to present peer review comments at an author user interface, e.g., as described in connection with 1014 in FIG. 10. The editorial manager 1132 further includes a comment processing component 1146 that that is configured to automatically associate the received comments with a corresponding section of the article and/or to separate types of comments for display to an author and/or editor, e.g., as described in connection with 1010 in FIG. 10. The editorial manager 1132 further includes a reference link component 1148 that that is configured to establish a link between one or more reference citations in the article and a copy of the corresponding references in order to display a copy of the reference at the peer reviewer user interface in response to a selection of the citation in the article, e.g., as described in connection with 1016 in FIG. 10. The editorial manager 1132 further includes a table/appendix link component 1153 that that is configured to establish a link between one or more table citations in the article and a copy of the corresponding table in order to display a copy of the table at the peer reviewer user interface in response to a selection of the citation in the article, e.g., as described in connection with 1018 and/or 1020 in FIG. 10. The editorial manager 1132 further includes a technology specific dictionary component 1152 that that is configured to present an option for a technology specific spelling or grammar check at the peer reviewer user interface, to receive a selection of particular type of technical dictionary and to perform a spelling check and/or grammar check by applying the particular type of technical dictionary, e.g., as described in connection any of the aspects of FIG. 12. The editorial manager 1132 further includes a comment preview component 1154 that that is configured to display a preview of the comments entered at the peer reviewer user interface, e.g., as described in connection with 1012 in FIG. 10. The reception component 1130 may be configured to receive an article for peer review, e.g., as described in connection with 1002 in FIG. 10. The editorial manager 1132 may include additional components configured to perform additional aspects of processing the article for presentation at the peer reviewer user interface, e.g., as described in connection with 1004 in FIG. 10.

The apparatus may include additional components that perform each of the blocks of the algorithm in the flowcharts of FIG. 1, 10, or 12. As such, each block in the flowcharts of FIG. 1, 10, or 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the system 1102, and in particular the communication manager 1104, includes means for receiving a written document for review; means for processing the written document for review at a user interface; means for displaying the written document at a first portion of the user interface; and means for receiving one or more comments about the written document at an entry component at a second portion of the user interface. The system may further include means for automatically associating each of the one or more comments entered at the second portion of the user interface with a portion of the written document selected at the first portion of the user interface. The system may further include means for displaying a preview of the entered comments at the user interface prior to submission of the entered comments to an editing system. The system may further include means for visually displaying, at the user interface, the first type of comments with a first format and display the second type of comments with a second format. The system may further include means for displaying at least the first type of comments at an editor user interface; and means for providing the second type of comments to the author. The system may further include means for generating a document including the first type of comments and the second type of comments received at the entry component from at least one peer reviewer; and means for transmitting the document comprising the first type of comments and the second type of comments to the editor user interface. The system may further include means for generating a document including the second type of comments and not the first type of comments received at the entry component from at least one peer reviewer; and means for transmitting the document comprising the second type of comments to the author. The system may further include means for establishing a link between one or more user selectable reference citations in the written document and a copy of a corresponding reference. The system may further include means for receiving a selection of a user selectable citation in the written document at the first portion of the user interface; and means for displaying the copy of the corresponding reference, in response to the selection. The system may further include means for establishing a link between one or more user selectable citations to a table in the written document and a copy of a corresponding table. The system may further include means for receiving a selection of a user selectable citation in the written document at the first portion of the user interface; and means for displaying the copy of the corresponding table, in response to the selection. The system may further include means for establishing a link between one or more user selectable citations to an appendix in the written document and a copy of a corresponding appendix. The system may further include means for receiving a selection of a user selectable citation in the written document at the first portion of the user interface; and means for displaying the copy of the corresponding appendix in response to the selection. The system may further include means for displaying a selectable option for a spelling check or grammar check for a plurality of technical fields; means for receiving a selection of one of the plurality of technical fields; and means for displaying results of the spelling check or the grammar check based on a selected technical field. The means may be one or more of the components of the system 1102, the communication interface 1122, and may include computer-readable memory and at least one processor configured to perform the functions recited by the means.

The specific order or hierarchy of blocks in the processes/flowcharts disclosed is an illustration of example approaches. Based upon design preferences, the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method for presenting a document for review at a user interface, comprising: receiving a written document for review; processing the written document for review at a user interface; displaying the written document at a first portion of the user interface; and receiving one or more comments about the written document at an entry component at a second portion of the user interface.

In aspect 2, the method of aspect 1 further includes automatically associating each of the one or more comments entered at the second portion of the user interface with a portion of the written document selected at the first portion of the user interface.

In aspect 3, the method of aspect 1 or aspect 2 further includes displaying a preview of the entered comments at the user interface prior to submission of the entered comments to an editing system.

In aspect 4, the method of aspect 3 further includes that the one or more comments about the written document include a first type of comments and a second type of comments.

In aspect 5, the method of aspect 4 further includes visually displaying, at the user interface, the first type of comments with a first format and display the second type of comments with a second format.

In aspect 6, the method of any of aspects 1-5 further includes that the user interface comprises a peer reviewer user interface, and the one or more comments about the written document include a first type of comments for an editor and a second type of comments for an author, the method further comprising: displaying at least the first type of comments at an editor user interface; and providing the second type of comments to the author.

In aspect 7, the method of aspect 6 further includes generating a document including the first type of comments and the second type of comments received at the entry component from at least one peer reviewer; and transmitting the document comprising the first type of comments and the second type of comments to the editor user interface.

In aspect 8, the method of aspect 7 further includes generating a document including the second type of comments and not the first type of comments received at the entry component from at least one peer reviewer; and transmitting the document comprising the second type of comments to the author.

In aspect 9, the method of any of aspects 1-8 further includes that the processing the written document for review at the user interface includes: establishing a link between one or more user selectable reference citations in the written document and a copy of a corresponding reference.

In aspect 10, the method of aspect 9 further includes receiving a selection of a user selectable citation in the written document at the first portion of the user interface; and displaying the copy of the corresponding reference, in response to the selection.

In aspect 11, the method of any of aspects 1-10 further includes that the processing the written document for review at the user interface includes: establishing a link between one or more user selectable citations to a table in the written document and a copy of a corresponding table.

In aspect 12, the method of aspect 11 further includes receiving a selection of a user selectable citation in the written document at the first portion of the user interface; and displaying the copy of the corresponding table, in response to the selection.

In aspect 13, the method of any of aspects 1-12 further includes that the processing the written document for review at the user interface includes: establishing a link between one or more user selectable citations to an appendix in the written document and a copy of a corresponding appendix.

In aspect 14, the method of aspect 13 further includes receiving a selection of a user selectable citation in the written document at the first portion of the user interface; and displaying the copy of the corresponding appendix in response to the selection.

In aspect 15, the method of any of aspects 1-14 further includes displaying a selectable option for a spelling check or grammar check for a plurality of technical fields; receiving a selection of one of the plurality of technical fields; and displaying results of the spelling check or the grammar check based on a selected technical field.

Aspect 16 is a system for document review, comprising: a memory; and at least one processor coupled to the memory and configured to perform the method of any of aspects 1-15.

Aspect 17 is a non-transitory computer-readable medium storing computer executable code for presenting a document for review at a user interface, the code when executed by a processor cause the processor to perform the method of any of aspects 1-15.

Aspect 18 is an apparatus for presenting a document for review at a user interface, comprising means to perform the method of any of claims 1-15.

What is claimed is:

1. A system for document review, comprising:
a memory; and
at least one processor coupled to the memory and configured to:
receive a written document for review;
process the written document for review at a user interface;
display the written document at a first portion of the user interface; and
receive one or more comments about the written document at an entry component at a second portion of the user interface.

2. The system of claim 1, wherein the memory and the at least one processor is further configured to:
automatically associate each of the one or more comments entered at the second portion of the user interface with a portion of the written document selected at the first portion of the user interface.

3. The system of claim 1, wherein the memory and the at least one processor is further configured to:
display a preview of entered comments at the user interface prior to submission of the entered comments to an editing system.

4. The system of claim 3, wherein the one or more comments about the written document include a first type of comments and a second type of comments.

5. The system of claim 4, wherein the memory and the at least one processor is further configured to:
visually display the first type of comments with a first format and display the second type of comments with a second format.

6. The system of claim 1, wherein the user interface comprises a peer reviewer user interface, and the one or more comments about the written document include a first type of comments for an editor and a second type of comments for an author, wherein the memory and the at least one processor are further configured to:
display at least the first type of comments at an editor user interface; and
provide the second type of comments to the author.

7. The system of claim 6, wherein the memory and the at least one processor are further configured to:
generate a document including the first type of comments and the second type of comments received at the entry component from at least one peer reviewer; and
transmit the document to the editor user interface.

8. The system of claim 6, wherein the memory and the at least one processor are further configured to:
generate a document including the second type of comments and not the first type of comments received at the entry component from at least one peer reviewer; and
transmit the document to the author.

9. The system of claim 1, wherein, as a part of processing the written document for review at the user interface, the memory and the at least one processor are further configured to establish a link between one or more user selectable reference citations in the written document and a copy of a corresponding reference.

10. The system of claim 9, wherein the memory and the at least one processor are further configured to:
receive a selection of a user selectable citation in the written document at the first portion of the user interface; and
display the copy of the corresponding reference, in response to the selection.

11. The system of claim 1, wherein, as a part of processing the written document for review at the user interface, the memory and the at least one processor are further configured to establish a link between one or more user selectable citations to a table in the written document and a copy of a corresponding table.

12. The system of claim 11, wherein the memory and the at least one processor are further configured to:
receive a selection of a user selectable citation in the written document at the first portion of the user interface; and
display the copy of the corresponding table, in response to the selection.

13. The system of claim 1, wherein, as a part of processing the written document for review at the user interface, the memory and the at least one processor are further configured to establish a link between one or more user selectable citations to an appendix in the written document and a copy of a corresponding appendix.

14. The system of claim 13, wherein the memory and the at least one processor are further configured to:
receive a selection of a user selectable citation in the written document at the first portion of the user interface; and
display the copy of the corresponding appendix in response to the selection.

15. The system of claim 1, wherein the memory and the at least one processor are further configured to:
display a selectable option for a spelling check or grammar check for a plurality of technical fields;
receive a selection of one of the plurality of technical fields; and
display results of the spelling check or the grammar check based on a selected technical field.

16. A method for presenting a document for review at a user interface, comprising:
receiving a written document for review;
processing the written document for review at a user interface;
displaying the written document at a first portion of the user interface; and
receiving one or more comments about the written document at an entry component at a second portion of the user interface.

17. The method of claim 16, further comprising:
automatically associating each of the one or more comments entered at the second portion of the user interface with a portion of the written document selected at the first portion of the user interface.

18. The method of claim 16, further comprising:
displaying a preview of entered comments at the user interface prior to submission of the entered comments to an editing system.

19. The method of claim 18, wherein the one or more comments about the written document include a first type of comments and a second type of comments, the method further including:
visually displaying, at the user interface, the first type of comments with a first format and display the second type of comments with a second format.

20. The method of claim 16, wherein the user interface comprises a peer reviewer user interface, and the one or more comments about the written document include a first type of comments for an editor and a second type of comments for an author, the method further comprising:
displaying at least the first type of comments at an editor user interface; and
providing the second type of comments to the author.

21. The method of claim 20, further comprising:
generating a document including the first type of comments and the second type of comments received at the entry component from at least one peer reviewer; and
transmitting the document comprising the first type of comments and the second type of comments to the editor user interface.

22. The method of claim 20, further comprising:
generating a document including the second type of comments and not the first type of comments received at the entry component from at least one peer reviewer; and
transmitting the document comprising the second type of comments to the author.

23. The method of claim 16, wherein the processing the written document for review at the user interface includes:
establishing a link between one or more user selectable reference citations in the written document and a copy of a corresponding reference;
receiving a selection of a user selectable citation in the written document at the first portion of the user interface; and
displaying the copy of the corresponding reference, in response to the selection.

24. The method of claim 16, wherein the processing the written document for review at the user interface includes:
establishing a link between one or more user selectable citations to a table in the written document and a copy of a corresponding table;
receiving a selection of a user selectable citation in the written document at the first portion of the user interface; and
displaying the copy of the corresponding table, in response to the selection.

25. The method of claim 16, wherein the processing the written document for review at the user interface includes:
establishing a link between one or more user selectable citations to an appendix in the written document and a copy of a corresponding appendix;
receiving a selection of a user selectable citation in the written document at the first portion of the user interface; and
displaying the copy of the corresponding appendix in response to the selection.

26. The method of claim 16, further comprising:
displaying a selectable option for a spelling check or grammar check for a plurality of technical fields;
receiving a selection of one of the plurality of technical fields; and
displaying results of the spelling check or the grammar check based on a selected technical field.
